(19) United States
(12) Patent Application Publication
(10) Pub. No.: US 2014/0068194 A1
(43) Pub. Date: Mar. 6, 2014

(54) PROCESSOR, INFORMATION PROCESSING APPARATUS, AND CONTROL METHOD OF PROCESSOR

(71) Applicant: FUJITSU LIMITED, Kawasaki-shi (JP)

(72) Inventors: DAISUKE KARASHIMA, Hachiouji (JP); Toru Hikichi, Inagi (JP); NAOYA ISHIMURA, Tama (JP)

(21) Appl. No.: 13/929,925

(22) Filed: Jun. 28, 2013

(30) Foreign Application Priority Data
Aug. 30, 2012 (JP) 2012-190442

(51) Int. Cl. G06F 12/08; G06F 12/12

(52) U.S. Cl. CPC G06F 12/0804; G06F 12/12
USPC 711/133; 711/143

(57) ABSTRACT

A processor is includes cache memory; an arithmetic processing section that a load request loading an object data stored at a memory to the cache memory; a cache control part patent a process corresponding to the received load request; a memory management part which requests the object data corresponding to the request from the cache control part and header information containing information indicating whether or not the object data is a latest for the memory, and receives the header information responded by the memory; and a data management part that manages a write control of the data to the cache memory, and receives the object data responded by the memory based on the request. The requested data is transmitted from the memory to the data management part held by a CPU node without being intervened by the memory management part.

### CROSS-REFERENCE TO RELATED APPLICATION

This application is based upon and claims the benefit of priority of the prior Japanese Patent Application No. 2012-190442, filed on Aug. 30, 2012, the entire contents of which are incorporated herein by reference.

### FIELD

The embodiments discussed herein are directed to a processor, an information processing apparatus, and a control method of the processor.

### BACKGROUND

There is an information processing apparatus in which plural CPU (Central Processing Unit) nodes as processors are connected with each other, and a memory as a main storage unit belonging to each CPU node is shared by each of the plural CPU nodes (for example, refer to Patent Documents 1, 2). Hereinafter, a data transfer method between nodes in a ccNUMA (cache coherent Non Uniform Memory Access, distributed shard memory) method made up of a cache control part and so on receiving a load request issued by an arithmetic processing section (CORE part) as illustrated in FIG. 14 is considered.

In FIG. 14, each of CPU nodes 10 (10A, 10B, 10C) has an arithmetic processing section (CORE part) 11 issuing the load request and so on and a secondary cache part 12. A primary cache memory is included in the arithmetic processing section (CORE part) 11. The secondary cache part 12 includes a cache control part 13, a cache memory part 14, a cache data management part 15, a memory management part 16, and a remote management part 17.

The cache control part 13 selects one request based on a priority order set in advance, and executes processes corresponding to the selected request. The cache memory part 14 is a secondary cache memory holding data blocks stored at a memory 18 being a main storage area. The cache data management part 15 is a resource of the CPU node 10 being a request source, and performs management of addresses and data relating to writing to a cache memory. The memory management part 16 manages information of the memory 18 being the main storage area managed as a home. The remote management part 17 receives a request from the memory management part 16 of the other CPU node, and transmits a data block when the request is hit at the cache memory of its own CPU node.

When the arithmetic processing section (CORE part) 11 issues the load request to the main storage area, the cache control part 13 judges the CPU node 10 where the memory 18 storing the requested data block belongs based on an address space definition defined by a system. For example, CPU-IDs are assigned to a certain address field in the address space definition, and it is judged which memory 18 of any of the CPU nodes 10 does store the data block based on the CPU-ID. Each data block is managed by unit of a cache line size, and all data blocks of the memory 18 have directory information (header information). Information indicating whether or not the data block is the latest one, information indicating which cache memory of any of the CPU nodes 10 has the data block, and so on are contained in the directory information.

A data transfer path at an information processing apparatus illustrated in FIG. 14 is described. In an example described below, the arithmetic processing section (CORE part) 11 of a CPU-A node 10A issues the load request to the main storage area. Note that function parts relating to data transfer are illustrated in FIG. 15 to FIG. 17 illustrated below, and the other function parts are not illustrated.

FIG. 15 is a view illustrating a transfer path when the data is held at a memory 18A belonging to the CPU-A node 10A issuing the load request. A cache control part 13A transmits a load request R101 to a cache data management part 15A, and a resource at the cache data management part 15A is secured. Besides, the cache control part 13A requests a data and directory information (R102) to the memory 18A via a memory management part 16A by the load request R101. The cache data management part 15A receives header information I101 containing the directory information and a data D101 transmitted from the memory 18A as a response for the request via the memory management part 16A (I102, D102). The cache data management part 15A transmits a data D103 to the cache control part 13A.

FIG. 16 is a view illustrating a transfer path when the cache control part 13A judges that a latest data is not held at the memory 18A belonging to the CPU-A node 10A issuing the load request but the latest data is held by a memory 18B belonging to a CPU-B node 10B. The cache control part 13A transmits a load request R201 to the cache data management part 15A, and a resource at the cache data management part 15A is secured. The cache data management part 15A transmits a load request R202 to the CPU-B node 10B, and a memory management part 16B receives it via a cache control part 13B (R203). The memory management part 16B of the CPU-B node 10B requests a data and directory information (R204) to the memory 18B. The memory management part 16B receives header information 1201 containing the directory information and a latest data D201 transmitted from the memory 18B as a response for the request. Further, the memory management part 16B transmits header information 1202 and a data D202 to the CPU-A node 10A, and the cache data management part 15A receives them. The cache data management part 15A transmits a data D203 to the cache control part 13A.

FIG. 17 is a view illustrating a transfer path when the cache control part 13A judges that a data is held at the memory 18A belonging to the CPU-A node 10A issuing the load request but a latest data exists at a cache memory of the other CPU-B node 10B by the directory information from the memory 18A. The cache control part 13A transmits a load request R301 to the cache data management part 15A, and a resource at the cache data management part 15A is secured. Besides, the cache control part 13A requests a data and directory information (R302) to the memory 18A via the memory management part 16A by the load request R301. The memory management part 16A receives information R303 indicating that header information I301 and a latest data exists at the other CPU-B node 10B from the memory 18A as a response for the request. The cache control part 13B and so on request the data existing at the cache memory of the CPU-B node 10B to a remote management part 17B (R304, R305). The remote management part 17B thereby transmits header information I302 and a data D301, and the cache data management part 15A receives them via the memory management part 16A of the CPU-A node 10A (I304, D302). The cache data management part 15A transmits data a D303 to the cache control part 13A.
[Patent Document 1] Japanese Laid-open Patent Publication No. 09-198309
[Patent Document 2] Japanese Laid-open Patent Publication No. 2003-44455

In the transfer path at the above-stated information processing apparatus, the memory 18 or the remote management part 17 transmits a data to the memory management part 16, and the memory management part 16 transmits the data to the cache data management part 15, and therefore, latency relating to data transfer becomes long, and it is wasteful. Besides, the resources of the memory management part 16 for the cache data management part 15 and the data are necessary because the data of the memory 18 is transmitted also to the memory management part 16 within the same CPU node 10.

### SUMMARY

An aspect of a processor includes: a cache memory; an arithmetic processing section that issues a load request loading an object data stored at a main storage unit to the cache memory; a control part that performs a process corresponding to the load request received from the arithmetic processing section; a memory management part that requests the object data corresponding to the request from the control part and header information containing information indicating whether or not the object data is a latest for the main storage unit, and receives the header information responded by the main storage unit based on the request for the main storage unit; and a data management part that manages a write control of the data acquired by the load request to the cache memory, and receives the object data responded by the main storage unit based on the request for the main storage unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating an example of a data transfer path at an information processing apparatus according to a present embodiment;

FIG. 2 is a view illustrating an example of the data transfer path at the information processing apparatus according to the present embodiment;

FIG. 3 is a view to explain a configuration example of a cache data management part according to the present embodiment;

FIG. 4 is a view to explain a write timing control according to the present embodiment;

FIG. 5A and FIG. 5B are views illustrating an example of header information and a data according to the present embodiment;

FIG. 6 is a view illustrating a correspondence between values of flags and states according to the present embodiment;

FIG. 7A and FIG. 7B are flowcharts illustrating an operation example from a read request to a writing to a cache memory according to the present embodiment;

FIG. 8 is a view illustrating a configuration example of a memory management part according to the present embodiment;

FIG. 9 is a flowchart illustrating an example of a resource acquisition process according to the present embodiment;

FIG. 10 is a view illustrating a flow of a data transfer in the data transfer path illustrated in FIG. 1;

FIG. 11 is a view illustrating a flow of a data transfer in the data transfer path illustrated in FIG. 2;

FIG. 12 is a view illustrating an example of a data transfer path in an information processing apparatus illustrated in FIG. 14;

FIG. 13 is a view illustrating a flow of a data transfer in the data transfer path illustrated in FIG. 12;

FIG. 14 is a view illustrating a configuration example of an information processing apparatus in which plural CPU nodes are interconnected;

FIG. 15 is a view illustrating an example of a data transfer path in the information processing apparatus illustrated in FIG. 14;

FIG. 16 is a view illustrating the example of the data transfer path in the information processing apparatus illustrated in FIG. 14; and

FIG. 17 is a view illustrating the example of the data transfer path in the information processing apparatus illustrated in FIG. 14.

### DESCRIPTION OF EMBODIMENT

Preferred embodiment will be explained with reference to accompanying drawings.

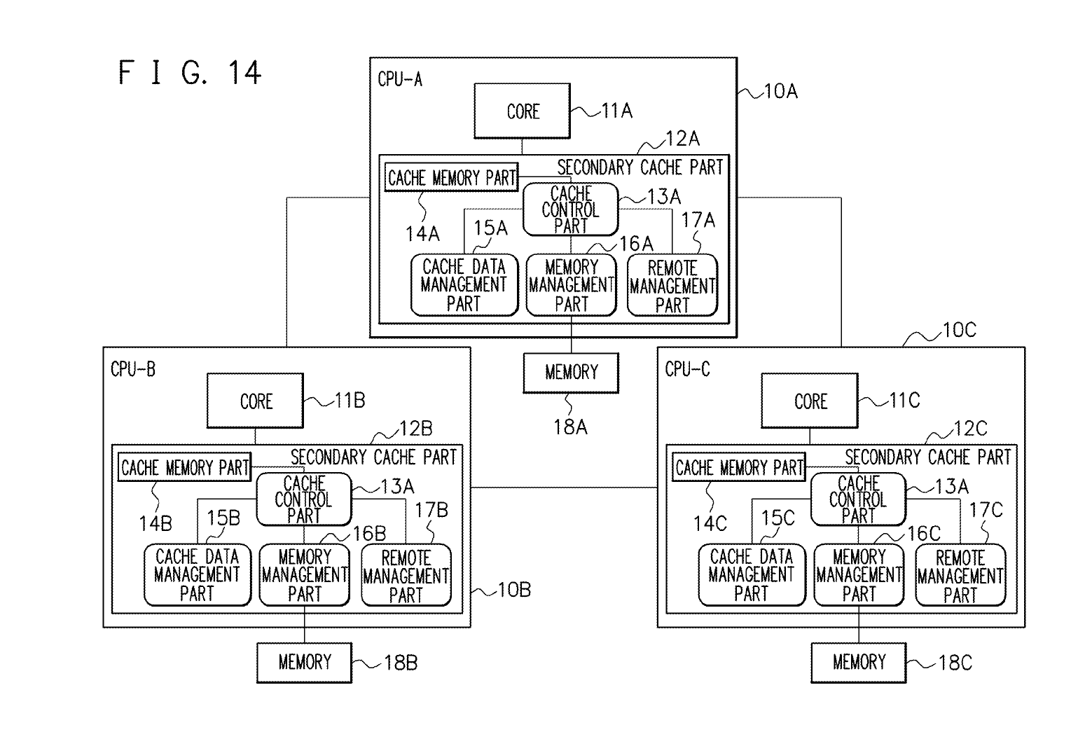

A configuration of an information processing apparatus according to an embodiment is as same as the information processing apparatus illustrated in FIG. 14. Namely, plural CPU nodes (10A, 10B, 10C) are connected with each other, and each of the CPU nodes 10 has an arithmetic processing section (CORE part) 11 issuing a load request and so on and a secondary cache part 12. The secondary cache part 12 includes a cache control part 13, a cache memory part 14, a cache data management part 15, a memory management part 16, and a remote management part 17.

The cache control part 13 selects one request based on a priority order set in advance, and performs processes corresponding to the selected request. The cache memory part 14 is the secondary cache memory, and holds data blocks stored at a memory 18 being a main storage area. The cache data management part 15 performs a management of addresses and data relating to writing to the cache memory including the cache memory part 14. The memory management part 16 manages information of the memory 18 being the main storage area managed as a home. The remote management part 17 receives a request from the memory management part 16 of the other CPU node, and transmits a data block when the cache memory of its own CPU node is hit for the request.

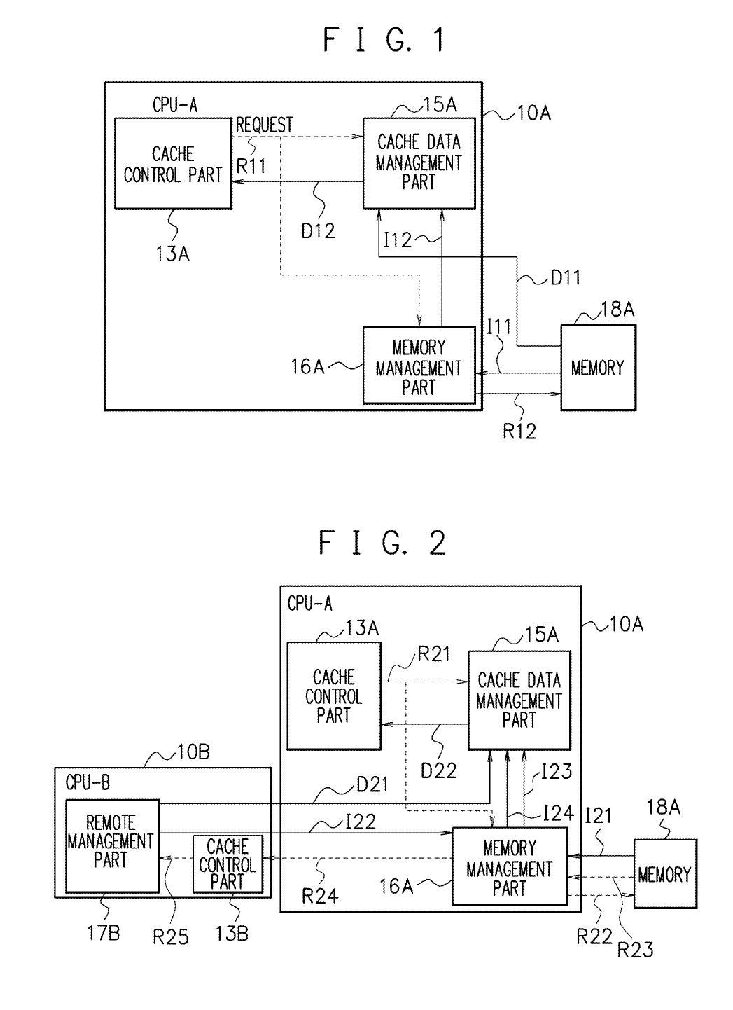

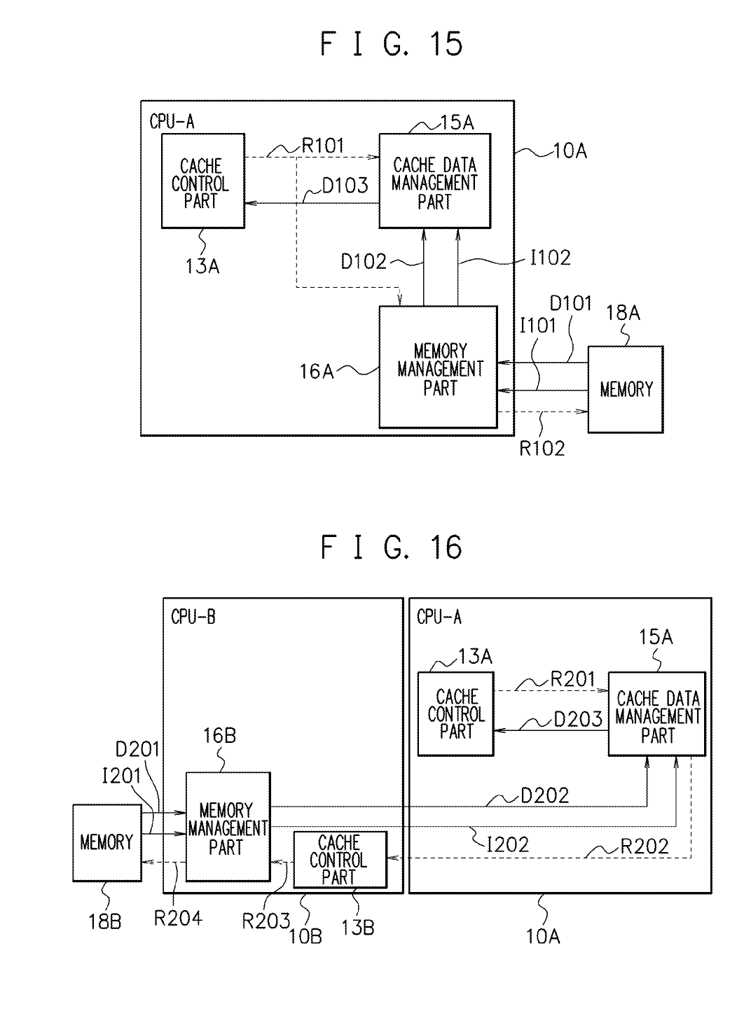

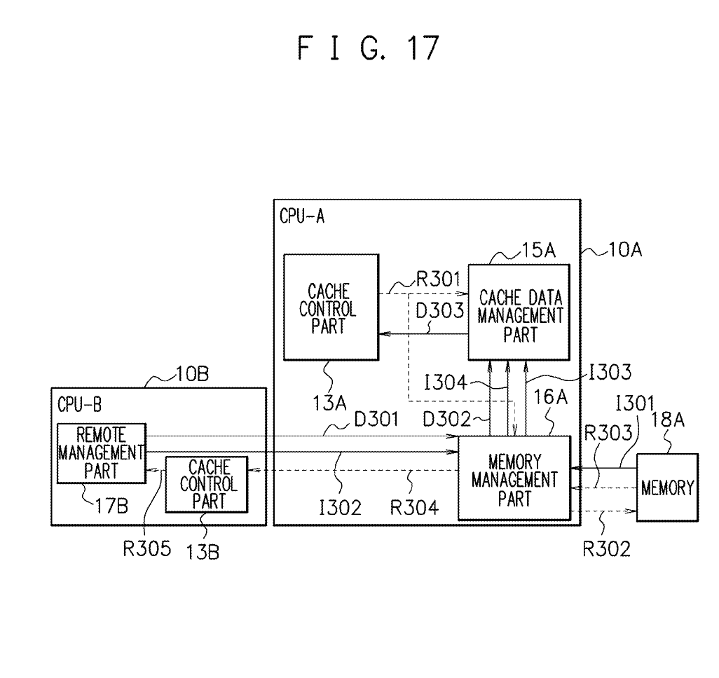

In data transfers illustrated in FIG. 15 and FIG. 17, the memory 18 or the remote management part 17 transmits a data to the memory management part 16, and the memory management part 16 transmits the data to the cache data management part 15. In the data transfer of the present embodiment, the memory 18 or the remote management part 17 transmits the data to the cache data management part 15 without being intervened by the memory management part 16 as illustrated in FIG. 1 and FIG. 2. Note that header information containing directory information is transmitted from the memory 18 or the remote management part 17 to the memory management part 16, and the memory management part 16 transmits it to the cache data management part 15 as same as the example illustrated in FIG. 15 and FIG. 17.

FIG. 1 and FIG. 2 are views illustrating examples of data transfer paths at an information processing apparatus according to the present embodiment. In FIG. 1 and FIG. 2, function parts relating to the data transfer are illustrated, and the other function parts are not illustrated. Besides, it is assumed that the arithmetic processing section (CORE part) 11 of a CPU-A node 10A issues the load request to the main storage area.

FIG. 1 is a view illustrating a transfer path when a data is held at the memory 18A belonging to the CPU-A node 10A issuing the load request in the present embodiment. A cache control part 13A transmits a load request R11 to the cache data management part 15A, and a resource at a cache data management part 15A is secured. Besides, the cache control part 13A requests a data and directory information to a memory 18A via a memory management part 16A (R12). A data D11 transmitted from the memory 18A as a response for the request R12 is received by the cache data management part 15A without being intervened by the memory management part 16A. Header information I11 containing the directory information transmitted from the memory 18A is transmitted to the cache data management part 15A via the memory management part 16A (I12). The cache data management part 15A transmits a data D12 to the cache control part 13A.

FIG. 2 is a view illustrating a transfer path when the cache control part 13A judges that a data is held at the memory 18A belonging to the CPU-A node 10A issuing the load request but a latest data exists at a cache memory of the other CPU-B node 10B by the directory information from the memory 18A in the present embodiment. The cache control part 13A transmits a load request R21 to the cache data management part 15A, and a resource at the cache data management part 15A is secured. Besides, the cache control part 13A transmits the load request R21 via the memory management part 16A, and requests a data and directory information (R22) to the memory 18A. The memory management part 16A receives information R23 indicating that header information 121 and a latest data exists at the other CPU-B node 10B from the memory 18A as a response for the request.

A cache control part 13B and so on request the data existing at the cache memory of the CPU-B node 10B to a remote management part 17B (R24, R25). A data D21 transmitted from the remote management part 17B to the CPU-A node 10A is received by the cache data management part 15A without being intervened by the memory management part 16A as a response for the request. Header information 122 containing directory information transmitted from the remote management part 17B to the CPU-A node 10A is transmitted to the cache data management part 15A via the memory management part 16A (I24). The cache data management part 15A transmits a data D22 to the cache control part 13A.

In the present embodiment, the memory 18 or the remote management part 17 transmits the data to the cache data management part 15 without being intervened by the memory management part 16 as illustrated in FIG. 1 and FIG. 2, and therefore, it is possible to make latency relating to the data transfer short. Besides, it is not necessary that the cache data management part 15 and the memory management part 16 within the same CPU node 10 hold the same data block, and therefore, it is possible to reduce a resource required for the holding of the data block, and it becomes possible to reduce a circuit area (an area of a CPU chip) and power consumption.

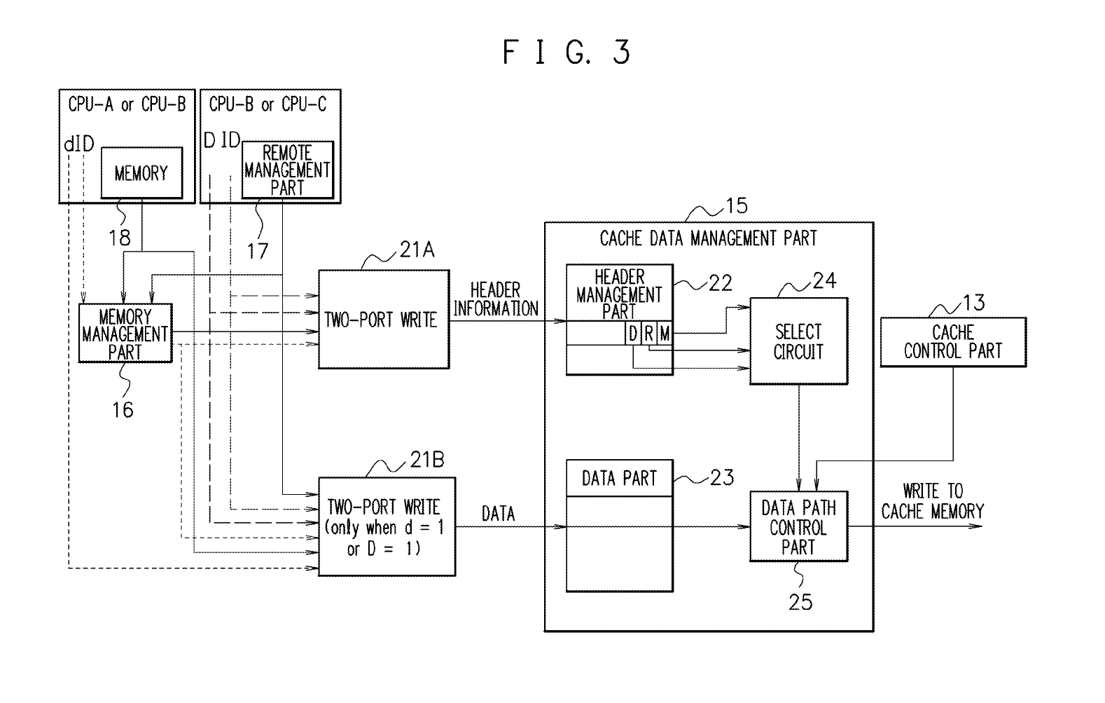

A configuration example of the cache data management part according to the present embodiment for the data transfer by the data transfer paths illustrated in FIG. 1 and FIG. 2 is described. FIG. 3 is a view to explain the configuration example of the cache data management part in the present embodiment. In FIG. 3, a reference numeral 13 is a cache control part of a CPU node 10 issuing a load request, and a reference numeral 15 is a cache data management part of the CPU node 10 issuing the load request. A reference numeral 18 is a memory where it is judged by the cache control part 13 that a data requested by the load request is stored, and a reference numeral 16 is a memory management part of the CPU node 10 to which the memory 18 belongs. A reference numeral 17 is a remote management part of the CPU node 10 having a cache memory which is determined to have a latest data by directory information.

The cache data management part 15 includes a header management part 22, a data part 23, a select circuit 24, and a data path control part 25. The data from the memory 18 (the memory management part 16 of the other CPU node) and the remote management part 17 are constantly transmitted for the cache data management part 15, and a write timing thereof is controlled by an ID.

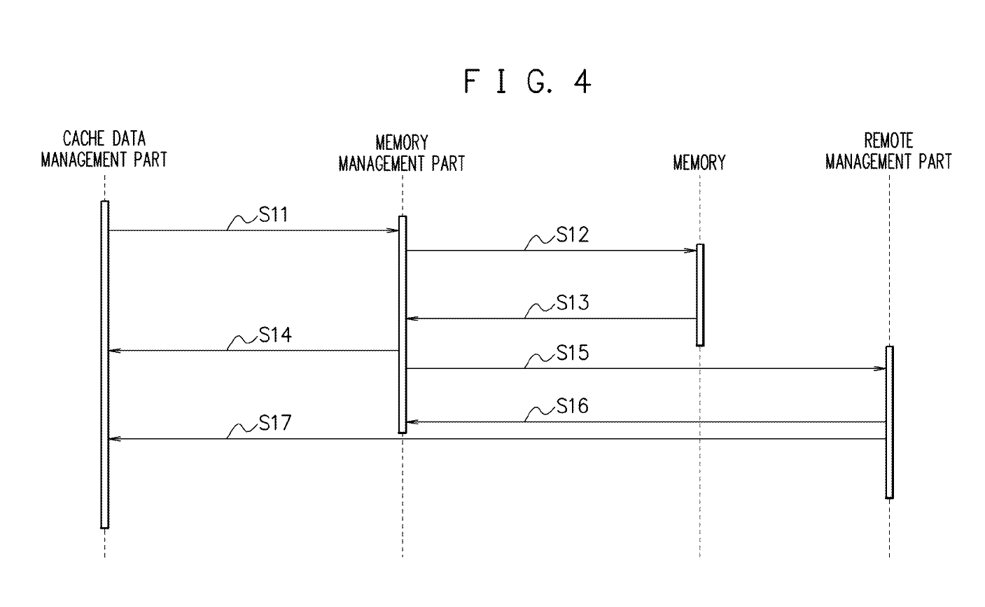

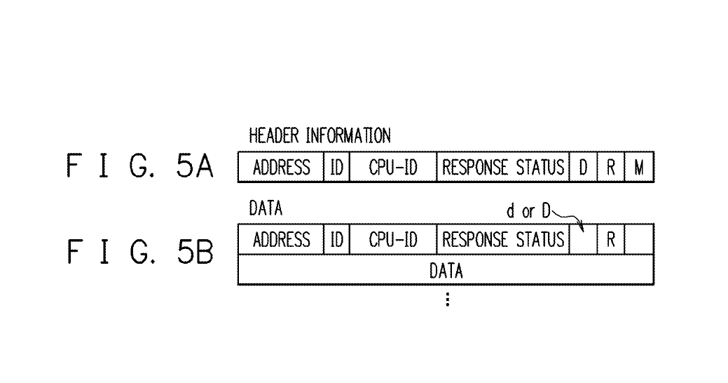

The write timing by the ID is described with reference to FIG. 4. Header information being packet control information contains a response status, control flags D, R, M, the ID, and a request CPU-ID in case of a communication between nodes as illustrated in FIG. 5A. The ID is an identifier of a request, and it is a format containing a cache management part ID and a memory management part ID. In an operation relating to the load request as illustrated in FIG. 4, at first, the cache data management part 15 transmits the cache data management part ID to the memory management part 16 (S11).

Next, the memory management part 16 transmits the cache data management part ID and the memory management part ID to the memory 18 (S12). The memory 18 transmits the cache data management part ID and the memory management part ID to the memory management part 16 (S13) for the above-stated operation, and the memory management part 16 transmits the cache data management part ID and the memory management part ID to the cache data management part 15 (S14). Besides, when a latest data exists at the other CPU node, the memory management part 16 transmits the cache data management part ID and the memory management part ID to the remote management part 17 of the other CPU node (S15) after the memory management part 16 receives the cache data management part ID and the memory management part ID from the memory 18. The remote management part 17 transmits the cache data management part ID and the memory management part ID to the memory management part 16 and the cache data management part 15 for the above-stated operation (S16, S17).

A timing of the ID transmitted from the memory 18 and a timing of the ID transmitted from the remote management part 17 are different as stated above, and therefore, the write timing of the data to the cache data management part 15 is controlled by the ID. At the cache data management part 15, a data from the memory 18 (the memory management part 16 of the other CPU node) or the remote management part 17 is received by a two-port write processing part 21B for an entry indicated by the ID, and performs the writing to the data part 23. Besides, at the cache data management part 15, header information from the memory management part 16 or the remote management part 17 is received by a two-port write processing part 21A for an entry indicated by the ID, and performs the writing to the header management part 22.

In the writing of data according to the present embodiment, the writing to the cache data management part 15 is instructed by two flags D and d contained in a header of a data illustrated in FIG. 5B. When the flag D indicating that a response data packet from the remote management part 17 or the memory management part 16 is with data, or the flag d indicating that a response data packet from the memory 18 is with data is in ON-state (a value is “1”), the data from the memory 18 (the memory management part 16 of the other CPU node) and the remote management part 17 is written to the entry of the cache data management part 15 indicated by the ID.

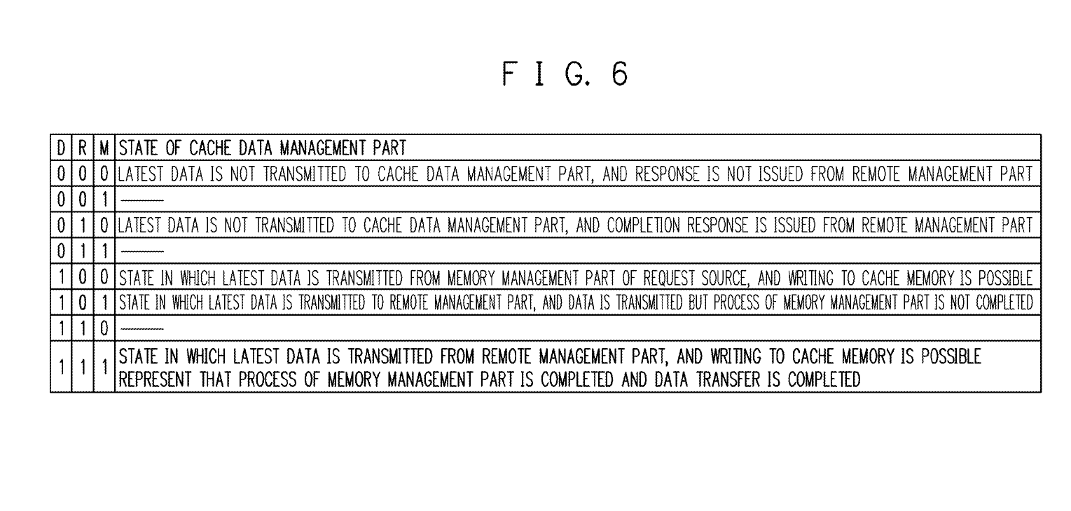

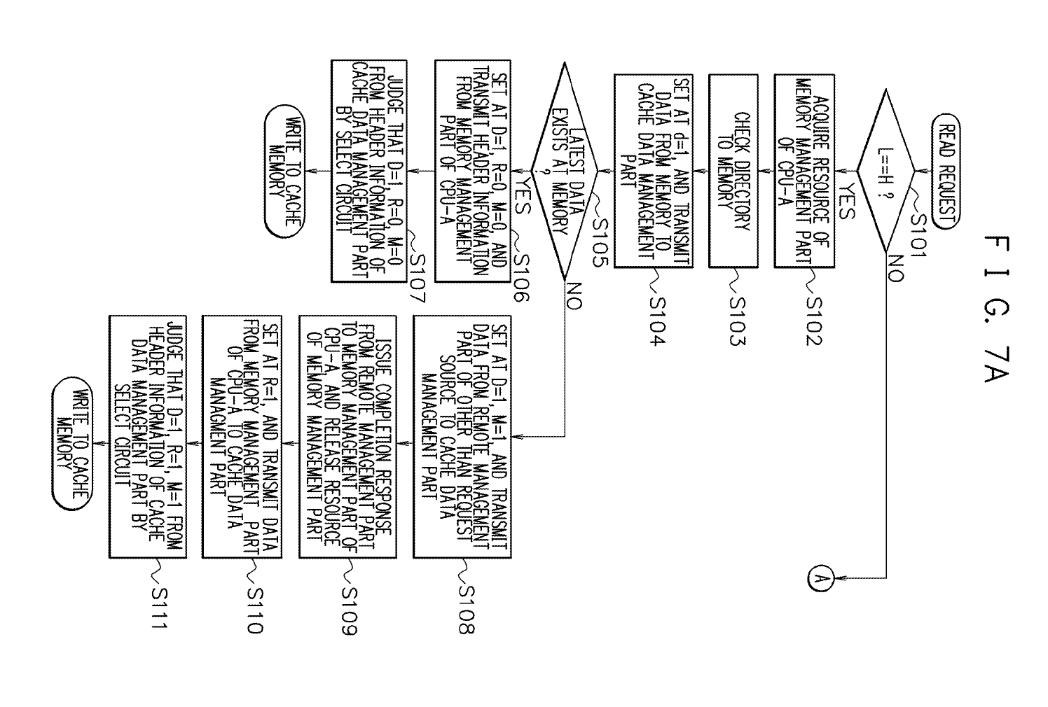

Here, when the data is a valid latest data, a completion of transfer is notified. Accordingly, for example, the writing of the latest data held by the data part 23 of the cache data management part 15 to the cache memory is performed with reference to the flags D, R, M of the header information held at the header management part 22 in the present embodiment. The flag D indicates that the data is held, the flag R indicates that the resource is secured at the memory management part 16, a completion response is transmitted from the remote management part 17, and a process completion of the memory management part 16 is indicated to the cache data management part 15, and the flag M indicates a response from the remote management part 17. Correspondences between values of the flags D, R, M and states thereof are illustrated in FIG. 6.

The cache data management part 15 judges the states of the flags D, R, M by the select circuit 24, sets the transmitted data as the latest data and represents a state in which a data valid indication is received when (D, R, M)=(1, 0, 0) or (1, 1, 1). Here, (D, R, M)=(1, 0, 0) represents a valid latest data from the memory 18, and (D, R, M)=(1, 1, 1) represents a valid latest data from the remote management part 17. These flags D, R, M are provided, and thereby, it is possible to discriminate the latest data from the memory 18 and the latest data from the remote management part 17, and to write to the cache memory. This data valid indication state and a request instruction from the cache control part 13 are transmitted to the data path control part 25, and a data is written from the data part 23 of the cache data management part 15 to the cache memory.

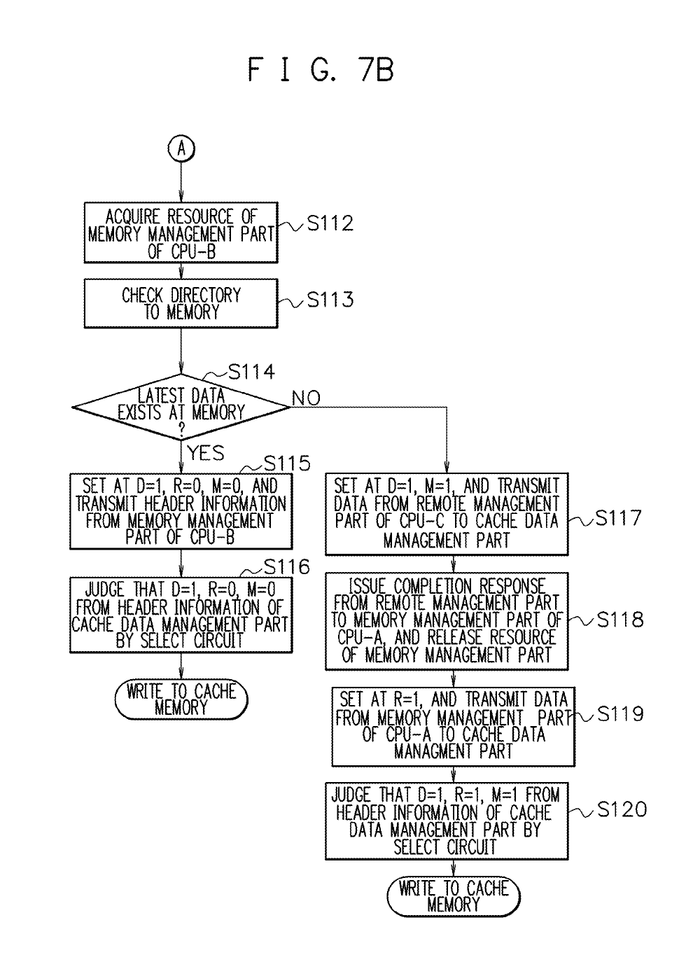

A flowchart of operations from the read request to the write to the cache memory while focusing on the flags is illustrated in FIG. 7A and FIG. 7B. An example illustrated in FIG. 7A and FIG. 7B represents when the read request is issued by the CPU-A node 10A.

When the read request is issued, the cache control part 13A of the CPU-A node 10A judges whether or not L==H (S101). Here, L H indicates that a requested data is stored at the memory 18 belonging to its own CPU node. Namely, the cache control part 13A judges whether or not the requested data is stored at the memory 18A at the step S101. When L==H as a result of the judgment at the step S101, a resource of the memory management part 16 of the CPU-A node 10A is secured (S102), and a directory at the memory 18A is checked (S103). The flag is set at d=1, and the data is transmitted from the memory 18 to the cache data management part 15A (S104).

Next, the memory management part 16A judges whether or not the latest data exists at the memory 18A based on directory information contained in header information (S105). When it is judged that the latest data exists at the memory 18A as a result of the judgment at the step S105, the memory management part 16A sets the flags at (D, R, M)=(1, 0, 0), and transmits the header information (S106). The cache data management part 15A judges that the flags of the header information are (D, R, M)=(1, 0, 0) by the select circuit 24 (S107), and performs the writing to the cache memory.

When it is judged that the latest data does not exist at the memory 18A as the result of the judgment at the step S105, the data is transmitted from the remote management part 17B (17C) of the CPU node other than the CPU-A node 10A to the cache data management part 15A while setting the flags at D=1, M=1 (S108). Next, a completion response is issued from the remote management part 17B (17C) to the memory management part 16A of the CPU-A node 10A, and the resource is released (S109). The memory management part 16A sets R=1, and the data is transmitted to the cache data management part 15A (S110). The cache data management part 15A judges that the flags of the header information are (D, R, M)=(1, 1, 1) by the select circuit 24 (S111), and performs the writing to the cache memory.

When L==H is not true as the result of the judgment at the step S101, the process goes to step S112. Here, the requested data is not stored at the memory 18A but stored at the memory 18B belonging to the CPU-B node 10B. At the step S112, a resource of the memory management part 16 of the CPU-B node 10B is secured (S112), and a directory at the memory 18B is checked (S113). The memory management part 16B judges whether or not the latest data exists at the memory 18B based on directory information contained in header information (S114). When it is judged that the latest data exists at the memory 18B as a result of the judgment at the step S114, the memory management part 16B sets the flags (D, R, M)=(1, 0, 0), and transmits the header information (S115). The cache data management part 15A judges that the flags of the header information are (D, R, M)=(1, 0, 0) by the select circuit 24 (S116), and performs the writing to the cache memory.

When it is judged that the latest data does not exist at the memory 18B as the result of the judgment at the step S114, the data is transmitted from the remote management part 17C of a CPU-C node 10C to the cache data management part 15A while setting the flags D=1, M=1 (S117). Next, a completion response is issued from the remote management part 17C to the memory management part 16A of the CPU-A node 10A, and the resource is released (S118). The memory management part 16A sets R=1, and the data is transmitted to the cache data management part 15A (S119). The cache data management part 15A judges that the flags of the header information are (D, R, M)=(1, 1, 1) by the select circuit 24 (S120), and performs the writing to the cache memory.

In the present embodiment, it is possible for the memory management part 16 to omit a data storage part 32 as for the request when the request source CPU node (CPU (L)) and the CPU node which has the data (CPU (H)) are the same (L==H). In the ccNUMA method, it is possible to share a vast main storage area by a number of CPU nodes, but it is preferable to tune software such that a local main storage area belonging to its own CPU node is to be accessed to enough increase processing performance. An OS (operation system) actually supporting the ccNUMA configuration and a development environment mount a function called as an MPO (Memory Placement Optimization), and it is programmed to access to the local main storage area.

There is a data base processing software as a usage in which an access ratio to a remote memory not belonging to its own CPU node is large, but a local request ratio: a remote request ratio is statistically approximately 1:1. Accordingly, there is no problem if the local request ratio: the remote request ratio is assumed to be 1:1 or the local request ratio is higher than the above when the general ccNUMA configuration is used. In the request when the request source CPU node (CPU (L)) and the CPU node having the data (CPU (H)) are the same, the data transfer is performed to the cache data management part 15 without being intervened by the data resource of the memory management part 16 by applying the technology of the present embodiment. Accordingly, the request when the request source CPU node (CPU (L)) and the CPU node having the data (CPU (H)) are the same does not use the data resource of the memory management part 16. On the other hand, the request when the request source CPU node (CPU (L)) and the CPU node having the data (CPU (H)) are not the same is intervened by the data resource of the memory management part 16.

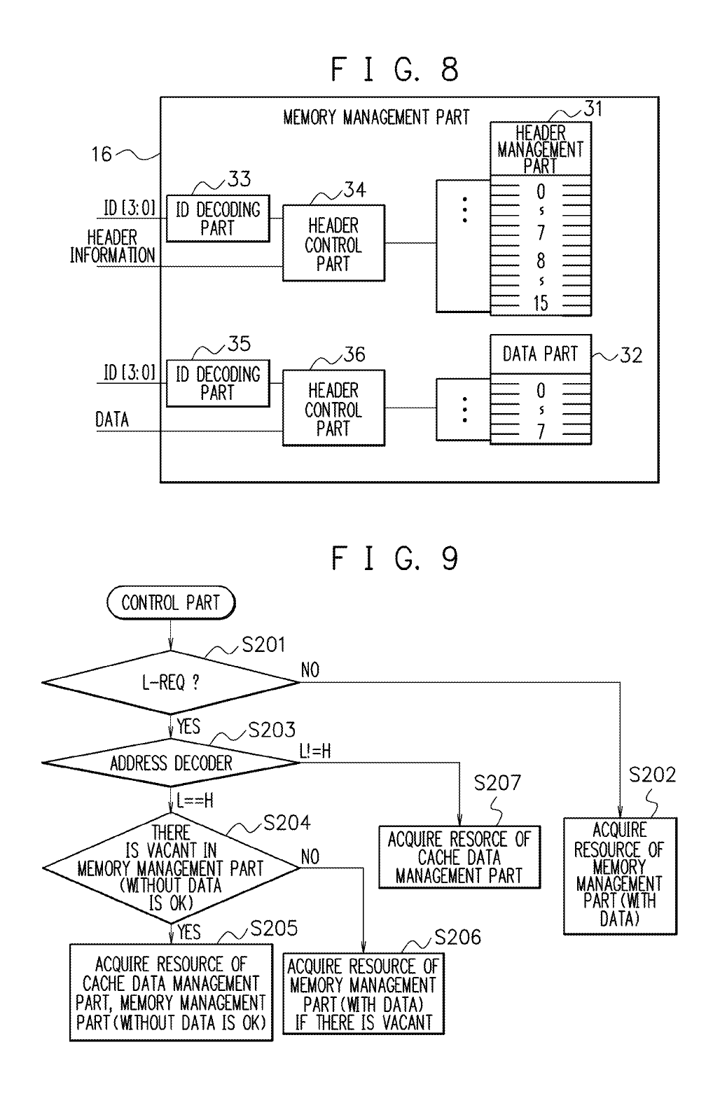

A configuration example of the memory management part in the present embodiment is illustrated in FIG. 8. The memory management part 16 includes a header management part 31, a data part 32, ID decoding parts 33, 35, and header control parts 34, 36. A control relating to an entry receiving the data is performed by the ID. For example, the IDs of “0” (zero) to seven are set to be entries receiving the data when the request source CPU node (CPU (L)) and the CPU node having the data (CPU (H)) are not the same. For example, the IDs of eight to 15 are set to be entries not receiving the data by the memory management part 16 but bypassing to the cache data management part 15 when the request source CPU node (CPU (L)) and the CPU node having the data (CPU (H)) are the same. At that time, the entries of which IDs are eight to 15 in the data part 32 are simply deleted. Besides, as for a function counting the number of valid entries, counting is performed by dividing into two parts of H_DATA_USE_CTR (with data), H_NODATA_USE_CTR (without data), to thereby avoid the resource from overflowing.

The memory management part in the present embodiment can be made up of an entry including both the header management part and the data part (the entry with the data part) and an entry including only the header management part (the entry without the data part) as stated above. It is controlled such that the request when the request source CPU node (CPU (L)) and the CPU node having the data (CPU (H)) are the same is allocated to the entry without the data part, and the request when they are not the same is allocated to the entry with the data part. Further, the request when the request source CPU node (CPU (L)) and the CPU node having the data (CPU (H)) are the same may be allocated to the entry with the data part when there is no vacant entry in the entries without the data part at the memory management part 16.

A flowchart as for a resource acquisition is illustrated in FIG. 9. Here, the case when the request source CPU node (CPU (L)) and the CPU node having the latest data (CPU (H)) are not the same is set to be L!=H, the read request from inside the request source CPU node is set to be L-REQ, and the read request from other than the request source CPU node is set to be R-REQ. The cache control part 13 manages as for transmission destination information, and the L-REQ or the R-REQ is generated from the information for the read request, and therefore, it is possible to discriminate whether the request is the L-REQ or the R-REQ. Further, the cache control part 13 decodes an address inside the header information, and thereby, it is possible to identify whether or not the request source CPU node (CPU (L)) and the CPU node having the latest data (CPU (H)) are the same.

The cache control part 13 judges whether or not the read request is the read request L-REQ from inside the request source CPU node (S201). As a result, when the read request is not the L-REQ, the cache control part 13 acquires a resource of the entry with the data part at the memory management part (S202). On the other hand, when the read request is the L-REQ, the cache control part 13 decodes the address, and judges whether or not the request source CPU node (CPU (L)) and the CPU node having the latest data (CPU (H)) are the same (S203). When the request source CPU node (CPU (L)) and the CPU node having the latest data (CPU (H)) are not the same, the cache control part 13 acquires a data resource of the cache data management part (S207).

When the read request is the L-REQ and the request source CPU node (CPU (L)) and the CPU node having the latest data (CPU (H)) are the same, the cache control part 13 judges whether or not the entry without the data part is vacant at the memory management part (S204). When the entry without the data part is vacant at the memory management part, the cache control part 13 acquires the data resource of the cache data management part and the resource of the entry without the data part of the memory management part (S205). On the other hand, when the entry without the data part is not vacant at the memory management part, the cache control part 13 acquires the resource of the entry when the entry with the data part of the memory management part is vacant (S206).

Optimum values of a ratio of the entry with the data part and the entry without the data part are different depending on usages thereof, but it is possible to reduce a CPU chip area and power consumption without lowering the performance in major part of the processes when the ratio is set to be approximately 1:1 in which a general remote request ratio becomes the maximum.

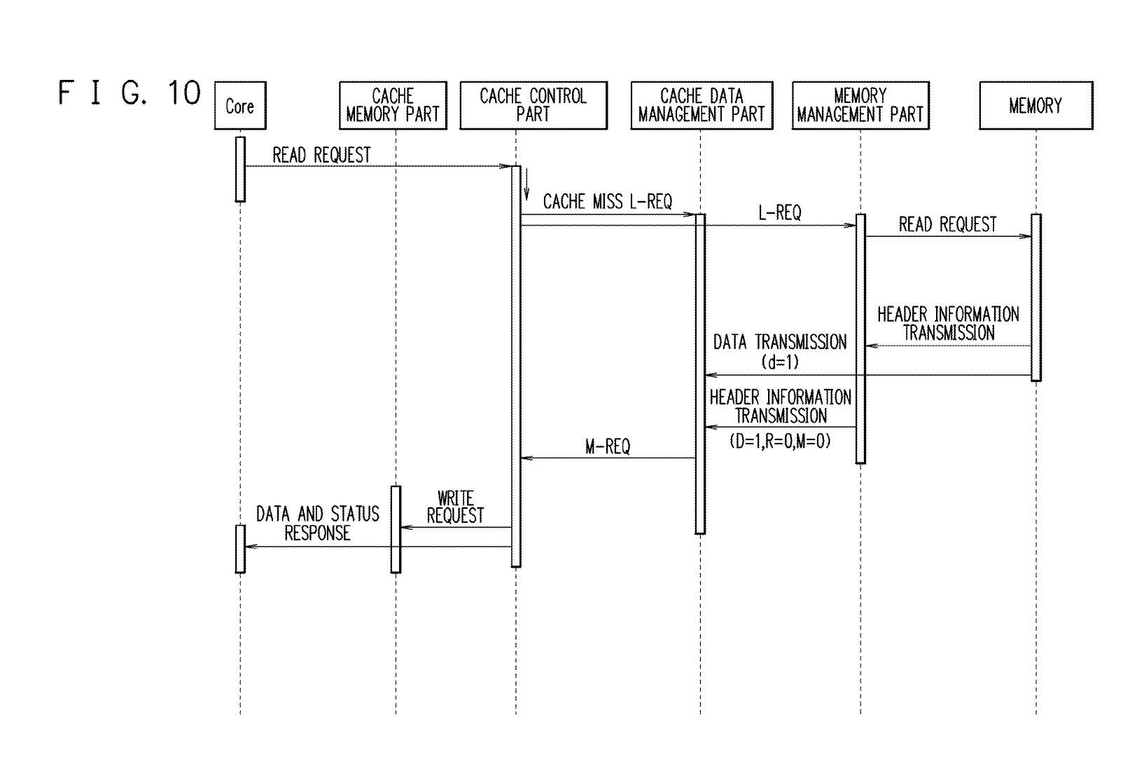

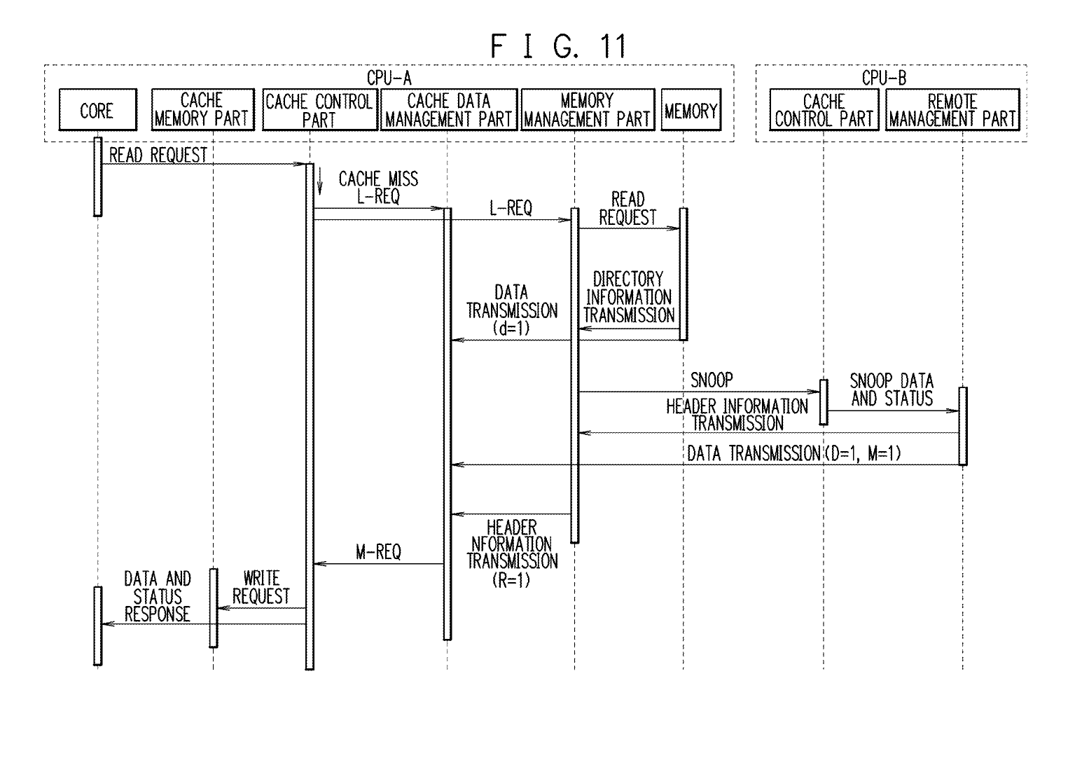

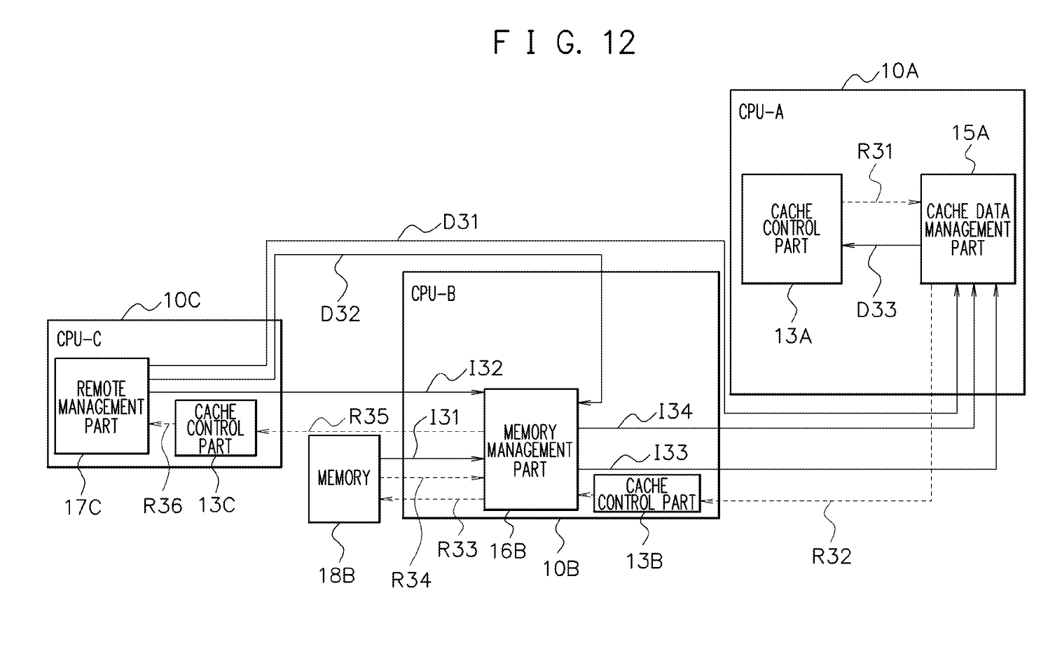

Flows of the data transfers at the data transfer paths illustrated in FIG. 1 and FIG. 2 are respectively illustrated in FIG. 10 and FIG. 11. The data transfer path illustrated in FIG. 12 is described. The transfer path illustrated in FIG. 12 is the transfer path when the cache control part 13A of the CPU-A node 10A judges that the data does not exist at the memory 18A belonging to the CPU-A node 10A issuing a load request R31, but the data exists at the memory 18B belonging to the CPU-B node 18B. Further, it is the transfer path transferring the data not only to the memory management part 16B but also to the cache data management part 15A when the data existing at the memory 18B is not the latest, and the latest data exists at a cache memory of the CPU-C node 10C from the directory information of the memory 18B.

The cache control part 13A transmits the load request R31 to the cache data management part 15A, and a resource at the cache data management part 15A is secured. The cache data management part 15A transmits a load request R32 to the CPU-B node 10B, and it is received by the memory management part 16B via the cache control part 13B. The memory management part 16B of the CPU-B node 10B requests a data and directory information to the memory 18B (R33). The memory management part 16B receives header information I31 and information R33 in which the latest data exists at the other CPU-C node 10C from the memory 18B as a response for the request.

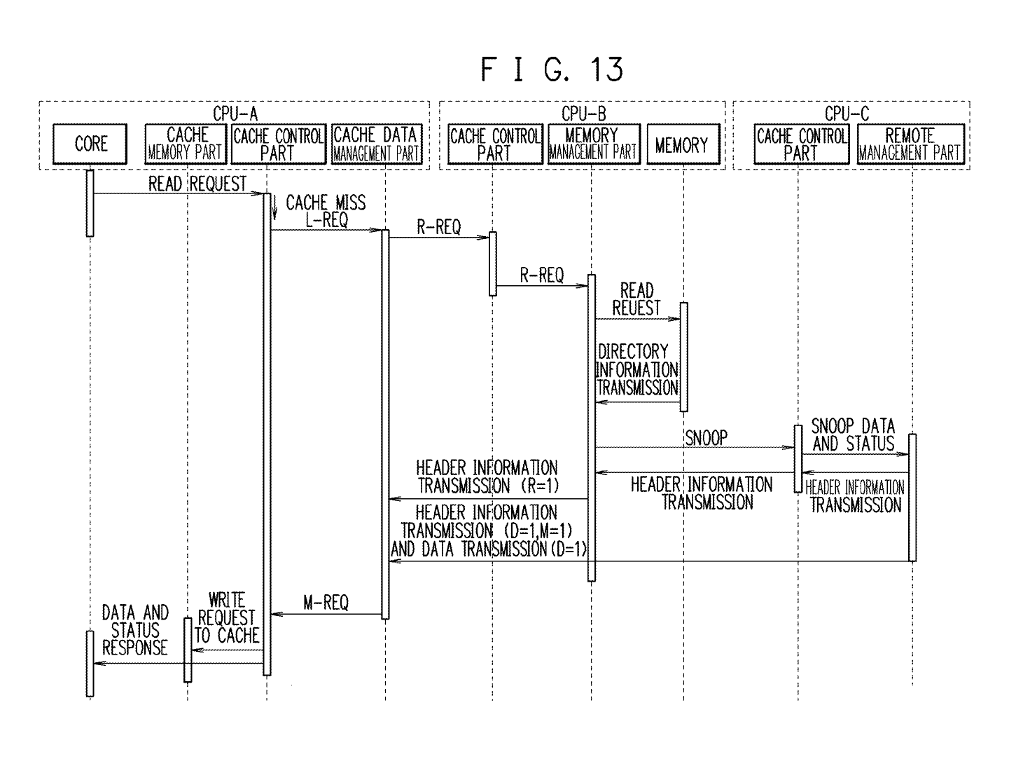

A cache control part 13C and so on requests the data existing at a cache memory of the CPU-C node 10C to a remote management part 17C (R35, R36). Header information 132 transmitted from the remote management part 17C by the above-stated request is transmitted to the cache data management part 15A of the CPU-A node 10A via the memory management part 16B of the CPU-B node 10B (I34). A data D31 transmitted from the remote management part 17C is transmitted to the cache data management part 15A of the CPU-A node 10A, and a data D32 is transmitted to the memory management part 16B of the CPU-B node 10B. The cache data management part 15A transmits a data D33 to the cache control part 13A. A flow of the data transfer at the data transfer path illustrated in FIG. 12 is illustrated in FIG. 13. When FIG. 11 and FIG. 13 are compared, it is possible to enable a control when the cache data management part 15A of the CPU-A node 10A receives a data from a remote management part of the other CPU node by the same control. Accordingly, it is possible to enable the cache data management part in the present embodiment by a logical configuration similar to the cache data management part 15 in which the data transfer path as illustrated in FIG. 12 is enabled. Note that M_REQ is a Move in request in FIG. 10, FIG. 11, and FIG. 14.

In an information processing apparatus in which plural CPU nodes are connected with each other, a requested data is transmitted from a memory to a data management part held by the CPU node without being intervened by a memory management part held by the CPU node, and thereby, it is possible to make latency relating to data transfer short in the information processing apparatus where the plural CPU nodes are connected with each other.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more the embodiments of the present invention have been described in detail, it should be understood that the various changes, substitutions, and alterations could be made hereto without departing from the spirit and scope of the invention.

What is claimed is:

1. A processor connected to a main storage unit, comprising:
a cache memory;
an arithmetic processing section that issues a load request loading an object data stored at the main storage unit to the cache memory;
a control part that performs a process corresponding to the load request received from the arithmetic processing section;
a memory management part that requests the object data corresponding to the request from the control part and header information containing information indicating whether or not the object data is a latest for the main storage unit, and receives the header information responded by the main storage unit based on the request for the main storage unit; and
a data management part that manages a write control of the data acquired by the load request to the cache memory, and receives the object data responded by the main storage unit based on the request for the main storage unit.

2. The processor according to claim 1,
wherein the memory management part requests an object data and header information for the other processor when the header information responded by the main storage unit indicates that a latest object data exists at a cache memory of the other processor, and receives the header information responded by the other processor based on the request for the other processor, and
the data management part receives the object data responded by the other processor based on the request for the other processor.

3. The processor according to claim 1,
wherein plural flags are contained in the header information, and
the data management part instructs writing of the object data corresponding to the header information to the cache memory when values of the plural flags of the header information supplied from the memory management part are in a certain combination.

4. The processor according to claim 3,
wherein the data management part includes:
a first holding part that holds the header information supplied from the memory management part;
a second holding part that holds the object data responded by the main storage unit;
a judgment circuit that judges whether or not the values of the plural flags of the header information held at the first holding part are in the certain combination; and
an output circuit that outputs the object data held at the second holding part in accordance with a judgment result at the judgment circuit.

5. The processor according to claim 1,
wherein the memory management part includes a first entry storing both the object data and the header information, and a second entry storing not the object data but the header information, and
allocates the second entry for the load request when the main storage unit connected to the processor issuing the load request has the object data requested by the load request.

6. An information processing apparatus, comprising:
a processor including:
a cache memory;
an arithmetic processing section that issues a load request loading an object data stored at a main storage unit to the cache memory;
a control part that performs a process corresponding to the load request received from the arithmetic processing section;
a memory management part that requests the object data corresponding to the request from the control part and header information containing information indicating whether or not the object data is a latest for the main storage unit, and receives the header information responded by the main storage unit based on the request for the main storage unit; and
a data management part that manages a write control of the data acquired by the load request to the cache memory, and receives the object data responded by the main storage unit based on the request for the main storage unit, and
the main storage unit that is connected to the processor, transmits the object data to the data management part of the processor for the request from the memory management part of the processor, and transmits the header information to the memory management part of the processor.

7. A control method of a processor connected to a main storage unit and having a cache memory, comprising:
issuing a load request loading an object data stored at the main storage unit to the cache memory by an arithmetic processing section included by the processor;
performing a process corresponding to the load request received from the arithmetic processing section by a control part included by the processor;
requesting the object data corresponding to the request from the control part and header information containing information indicating whether or not the object data is a latest for the main storage unit, and receiving the header information responded by the main storage unit based on the request for the main storage unit by a memory management part included by the processor; and
managing a write control of the data acquired by the load request to the cache memory and receiving the object data responded by the main storage unit based on the request for the main storage unit by a data management part included by the processor.
